(19) United States
(12) Patent Application Publication
(10) Pub. No.: US 2014/0288702 A1
(43) Pub. Date: Sep. 25, 2014

(54) Robot system and method for the removal of bolts from haulage truck wheels

(71) Applicant: Hugo Salamanca, Santiago (CL)

(72) Inventor: Hugo Salamanca, Santiago (CL)

(21) Appl. No.: 11/595,960

(22) Filed: Nov. 13, 2006

Related U.S. Application Data
(60) Provisional application No. 60/734,975, filed on Nov. 10, 2005.

(51) Int. Cl. G06F 19/00

(52) U.S. Cl. 700/245; 901/15

(57) ABSTRACT

The robotic system for the removal of bolts from haulage truck wheels is comprised mainly of an anthropomorphous robotic manipulator of at least 5 degrees of freedom (1), with a system for tightening and removal (2) which allows taking bolts from a drawer rack (3) located on a mobile equipment (4). The operator indicates the beginning of the operations as well as the key positions for the activity development. The reposition of new bolts and the relocation of the mobile system is presently carried out by the operator. In this regard, most of the major problems associated to the safety of the personnel and a decreasing of availability are eliminated.

### CROSS-REFERENCE TO RELATED APPLICATIONS

This application claims the benefit of provisional patent application Ser. No. 60/734,975, filed 2005 Nov. 10 by the present inventor.

### FEDERAL SPONSORED RESEARCH

Not Applicable

### SEQUENCE LISTING OR PROGRAM

Not Applicable

### BACKGROUND

1. Field of Invention

This invention relates to the use of robotic technology in mining industry, specifically in haulage trucks to remove bolts from its wheels.

2. Prior Art

One of the first stages in the mineral extraction process is the ore deposit exploitation, which is intended to extract the material containing the ore. The basic operations in mining exploitation are the following: Drilling and Blasting, Loading and Transport.

During drilling, percussion drills are used to drill boreholes of different sizes. They are made in such a way that the boreholes can be vertical or inclined. Once this is completed, the bench is prepared for blasting, and the explosives are put into the holes. Thus, during the blasting, electrical systems with time delay are used to detonate the explosives. The mineral will be broken and projected generating a new free side for the explosion of the next step or working elevation.

The layout of blastings and the number and type of explosives allow to project the mineral towards a certain place, as well as to control the maximum size of the resulting particle, so loading, transport and crushing of the particles do not present any problems. The blasted material increases in size towards the bottom of the bench. The material is loaded onto trucks with hydraulic or cable shovels and removed from the mine afterwards. The sterile material is moved to the disposal facilities and the valuable material to the primary crusher. Due to the huge amount of material generated by the transportation process inside the mine, this procedure is complex and it is necessary to improve the operation. Basically, during the operation, keeping the equipment, shovels and trucks operating at their maximum is sought for, and for this, detection systems and systems for assigning tasks are available so as all the shovels are being used and no trucks are waiting.

The removal of wheels from haulage trucks is one of the current processes applied for the maintenance and operation of the haulage trucks in the different mining operators throughout the world. This process uses specialized supporting equipment which allows this task. To carry out this task implies a physical effort and the repeatability factor increases the possibility of occupational diseases for those who carry out the activity.

Another important aspect is the time it takes to complete the activity which means less availability of the equipment, leading to huge losses of productivity.

Some of the disadvantages of the actual method to remove the bolts from haulage truck wheels are:
Less availability of the equipment, which means a decrease in production.
Costs associated to the personnel involved in the manual and/or mechanical reposition of bolts.
The current bolt removal process is a task which implies a high accident risk rate.
The operators in charge of the manual reposition are subjected to a constant physical demand.
Due to the above, a robot system and method have been developed for automatic bolt removal from haulage trucks wheels.

### SUMMARY

A robotic system and method to remove/tighten the bolts from haulage trucks in mining industry.

### DRAWINGS—FIGURES

FIG. 1 View of the general plant of a robot system.

FIG. 2 View from the back of the truck of a robotic system removing the bolts from haulage trucks wheel.

FIG. 3 Front view of a haulage truck wheel during robotic system operation.

### REFERENCE NUMERALS

1. Robot

2. Tightening and removal system

3. Drawer rack

4. Mobile equipment

### DETAILED DESCRIPTION

This invention relates to a new robot system and method for automatically removing the bolts from haulage truck wheels through anthropomorphous robotic arms of at least 5 degrees of freedom which are installed on a mobile equipment.

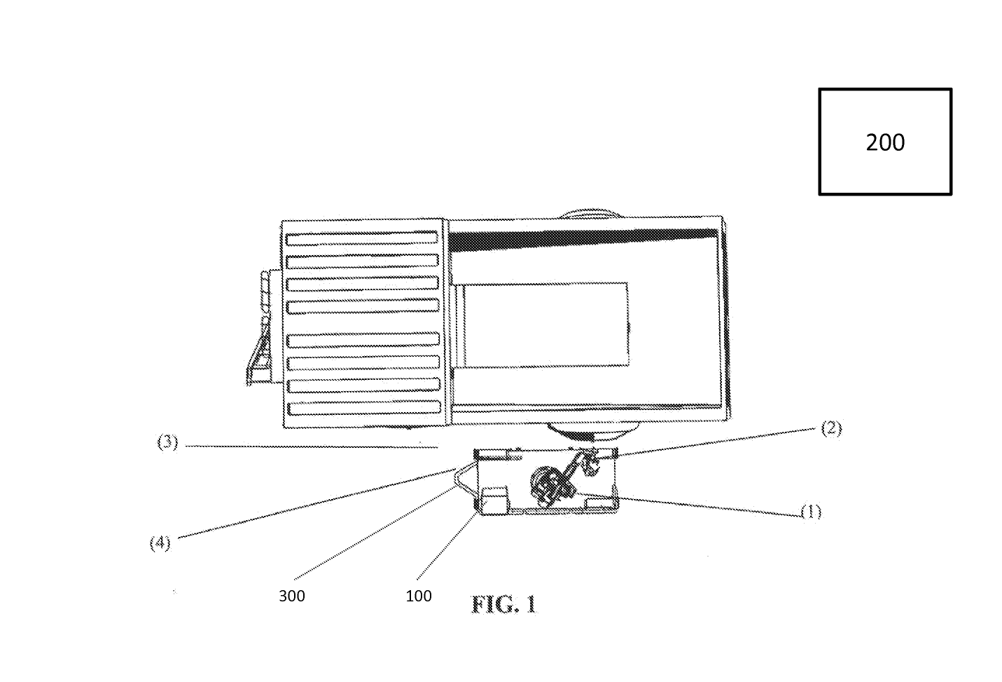

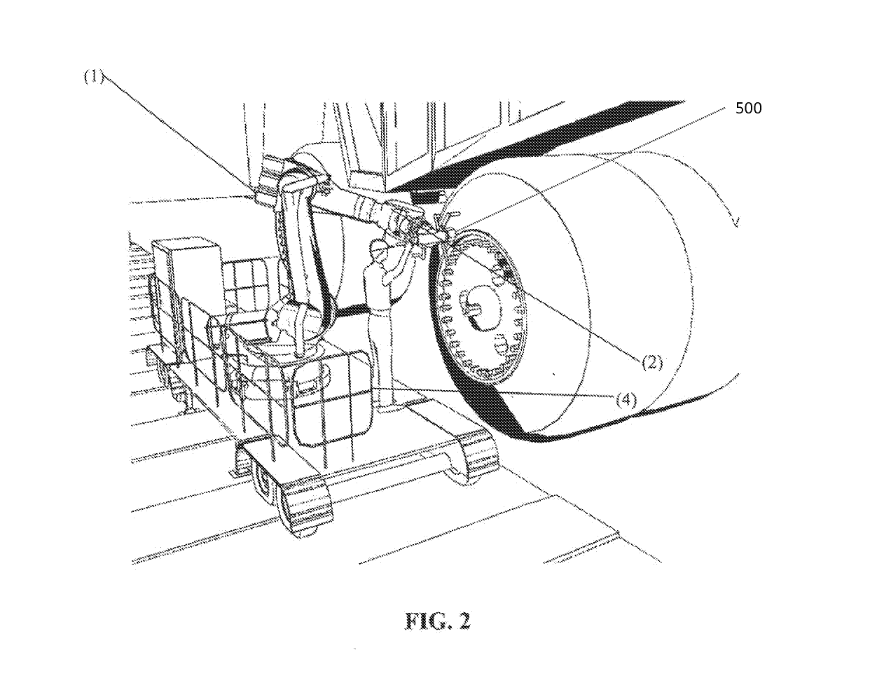

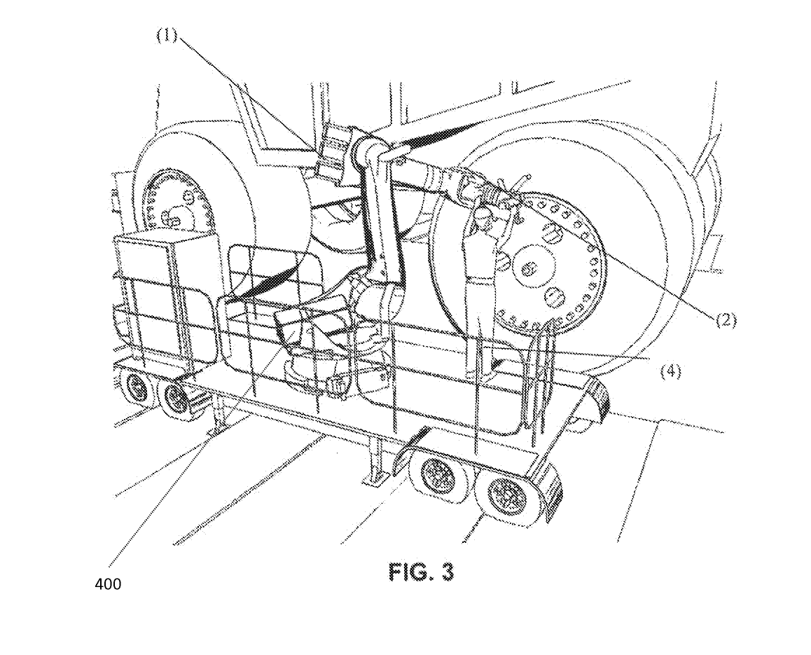

With reference to FIG. 1, FIG. 2 and FIG. 3, the robotic system for the removal of bolts from haulage trucks is composed mainly of an anthropomorphous robotic manipulator of at least 5 degrees of freedom (1), provided with communication, acquisition and control system, with a tightening and removal system (2) which allows to take the bolts from a drawer rack (3) located on a mobile equipment (4). The operator indicates the beginning of the operations as well as the key positions for the development of the activity. The reposition of new bolts and the relocation of the mobile system is carried out by the operator.

1-10. (canceled)

11. A method for replacing bolts in wheels of haulage trucks using a robotic manipulator,; said manipulator including a robotic arm of at least five degrees of freedom, a gripper for holding a bolt, analog or digital sensors, and a control system; comprising the steps of:
locating a bolt with at least one of said sensors,
with said gripper gripping and removing a bolt housed in a wheel of a haulage vehicle thereby leaving a slot,
with at least one of said sensors locating a replacement bolt,
with said gripper obtaining and holding said a replacement bolt,
said manipulator manipulating said replacement bolt to the vicinity of said wheel, and
with said gripper inserting and tightening said replacement bolt into said slot in said wheel.

12. The method of claim 11 wherein said manipulator communicates with a remote control system directly or through a PLC (programmed logic controller) interface.

13. The method of claim 11 wherein said manipulator includes the capability of obtaining and interpreting information from at least one of said analogue or digital sensors.

14. The method of claim 11 wherein said manipulator includes the capability of generating analogue or digital signals.

15. The method of claim 11 wherein said manipulator further includes a pneumatic or hydraulic system.

16. The method of claim 11 wherein said manipulator is mounted on a fixed or mobile support.

17. The method of claim 11 wherein said manipulator includes an electrical system driven by three-stage induction motors with vectorial or scalar control.

18-19. (canceled)

20. The method of claim 11 wherein the system operates automatically.

21. The method of claim 11 wherein said inserting and tightening occurs after repositioning of said manipulator by an operator.

22. The method of claim 11 wherein the system operates semi automatically.
